(19) United States
(12) Patent Application Publication
(10) Pub. No.: US 2023/0253807 A1
(43) Pub. Date: Aug. 10, 2023

(54) Battery and Charging Case

(71) Applicant: Pale Blue Earth Inc, Park City, UT (US)

(72) Inventors: Thomas BISHOP, Park City, UT (US); Jeffrey Earl, Park City, UT (US); Kevin Horsburgh, Park City, UT (US); David Vogt, Park City, UT (US)

(73) Assignee: Pale Blue Earth Inc, Park City, UT (US)

(21) Appl. No.: 17/665,344

(22) Filed: Feb. 4, 2022

(51) Int. Cl. H02J 7/00; H02J 50/10; H01M 10/44

(52) U.S. Cl. CPC H02J 7/0045; H02J 7/0049; H02J 50/10; H02J 7/0013; H01M 10/441

(57) ABSTRACT

The specification describes a charging device that includes a housing forming one or more cylindrical cavities that each receive a rechargeable battery, the one or more cylindrical cavities each having a magnet and an end that includes both a positive terminal and a negative terminal. The charging device further includes a status indicator for one or more of the rechargeable batteries a status indicator for one or more of the rechargeable batteries. The charging device further includes an antenna. The charging device further includes an induction charging system.

### FIELD

The described embodiments relate generally to rechargeable batteries and a rechargeable battery case.

### BACKGROUND

The use of portable, rechargeable batteries has been rapidly increasing in recent years. Rechargeable batteries are used for power not only in traditional areas, such as flashlights and small electronic devices, but also in heavy duty power tools, temporary power sources, and even vehicles.

### SUMMARY

In some embodiments, a charging device includes a housing forming one or more cylindrical cavities that each receive a rechargeable battery, the one or more cylindrical cavities each having a magnet and an end that includes both a positive terminal and a negative terminal. The charging device further includes a status indicator for one or more of the rechargeable batteries a status indicator for one or more of the rechargeable batteries. The charging device further includes an antenna. The charging device further includes an induction charging system.

In some embodiments, the positive terminal and the negative terminal are cylindrical and the negative terminal surrounds the positive terminal. In some embodiments, the positive terminal and the negative terminal are cylindrical and the positive terminal surrounds the negative terminal. In some embodiments, the positive terminal and the negative terminal are separated by an electronically insulative material. In some embodiments, the status indicator includes a representation of a battery with a lightning bolt that indicates when the rechargeable battery is charging. In some embodiments, the status indicator includes one or more lights that each change color to indicate a state of the rechargeable battery or that the rechargeable battery is charged. In some embodiments, the status indicator includes one or more of a progress bar or a light-emitting diode that changes color based on a progress level of the rechargeable battery. In some embodiments, the housing further includes one or more light pipes that attaches from the rechargeable battery to the housing. In some embodiments, the housing further includes a platform that includes the induction charging system. In some embodiments, the battery case further includes a first port that is a power-in port and a power-out port and a second port that is a power-out port. In some embodiments, the antenna includes one or more of a one or more of a radio frequency identification (RFID), Bluetooth (BT), Bluetooth Low Energy (BLE), near field communication (NFC), or WiFi for communication with one or more of a user device or a server.

In some embodiments, a battery includes a housing comprising a positive terminal forming a cylinder, electronically insulation material surrounding the positive terminal, and a negative terminal forming a ring that surrounds the insulation material and the cylinder. In some embodiments, the battery is one or more of a AA battery, a AAA battery, a camera battery, or a lithium-ion rechargeable battery. In some embodiments, the battery further includes a state of charge indicator that indicates when the battery is charged. The state of charge indicator may be located on top of the battery or on a side of the battery.

In some embodiments, a computer-implemented method includes receiving a status of one or more rechargeable batteries from a battery case, generating graphical, numerical, visual, or other data about the status of the one or more rechargeable batteries, and displaying the graphical data about the status of the one or more rechargeable batteries.

The specification describes multiple advantages. A first advantage is that the battery case includes both charging inside the case and also Qi charging through an induction charging system. A second advantage is that the batteries are rechargeable inside the battery case with a single-end contact. This is achieved by a specially designed positive and negative terminal of a battery that are separated by an electronically insulative material. A third advantage is that the battery case has a lid and magnets to keep the batteries secure and protected during storage and transport. A fourth advantage is convenience for the user for placing or removing the batteries. A fifth advantage is being able to charge the removable batteries via the on-board battery when access to external power is not available. A sixth advantage is the ability to use the on-board batter and/or the removeable batteries to charge an external device.

### BRIEF DESCRIPTION OF THE DRAWING

The disclosure is illustrated by way of example, and not by way of limitation in the figures of the accompanying drawings in which like reference numerals are used to refer to similar elements.

FIG. 1 illustrates a profile view of a battery case with the batteries inside the case and a profile view of an empty battery case, according to some embodiments.

FIG. 2 illustrates a profile view of the battery case from the front and the back with a closed lid, according to some embodiments.

FIG. 3 illustrates a top-down view of the battery case with the batteries inside, a detailed view of the inside of the battery case, and a side view of the battery case, according to some embodiments.

FIGS. 4A-C illustrates examples of batteries with state of charge indicators, according to some embodiments.

FIG. 5 illustrates a side view of the batteries inside a package card, according to some embodiments.

FIG. 6 illustrates an exploded view of the batteries inside a package card, according to some embodiments.

FIG. 7 illustrates an exploded top-down view of batteries inside a package card, according to some embodiments.

FIG. 8 illustrates a top view of the batteries inside a package card, according to some embodiments.

FIG. 9 illustrates cases with multiple batteries inside package cards, according to some embodiments.

FIG. 10 illustrates hardware components of the battery case, according to some embodiments.

FIG. 11 illustrates a computing device that includes software that communicates with the battery case, according to some embodiments.

### DETAILED DESCRIPTION OF THE INVENTION

In some embodiments, a charging device is a battery case that includes a Qi-enabled rechargeable battery case for the consumer market and includes batteries that are configured to recharge within the case with a single-end contact. In some embodiments, the battery case is configured for induction charging by placing the batteries on a surface of the battery case. In some embodiments, the battery case charges the batteries three ways: charging in the battery case while the battery case is plugged into an external power source; charging in the battery case when not plugged in by pulling power to charge from an on-board battery; or charging in the case using an induction system.

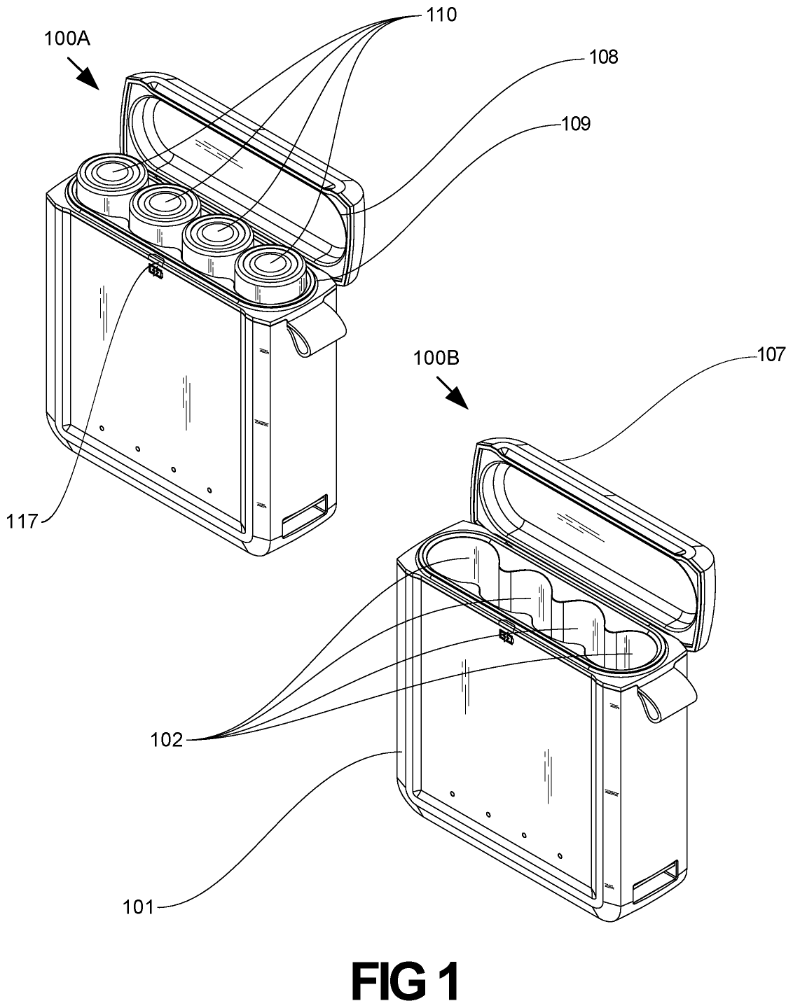

Turning to FIG. 1, a profile view of a battery case 100A with the batteries 110 inside the case and a profile view of an empty battery case 100B are illustrated. The battery case 100 includes a housing 101 that has peripheral walls forming a generally rectangular shape with angled edges. Although the edges are shown with angles, it is to be understood that other housing 101 shapes are possible.

The housing 101 may be a unitary, monolithic structure formed from a rigid material and manufactured from plastic or metallic, or a more flexible material, such as fabric. In some embodiments, the housing 101 is formed from an elastomeric material, such as silicone, thermoplastic polyurethane, or any other appropriate material. Alternatively, the housing 101 may be formed from multiple discrete parts (of the same or different materials). For example, the lid may be formed from an elastomeric material, while other portions of the case (e.g., the sides of the housing 101) may be formed from a rigid material.

The housing 101 includes side walls, end walls, a bottom, a top, and a lid 107. In some embodiments, the top includes a lip 109. In some embodiments, the housing 101 includes side walls, end walls, a bottom, a top, and no lid. The housing 101 forms cylindrical cavities 102 that each receive a battery 110. In this embodiment, there are four cavities 102.

In embodiments where the housing 101 includes a lid 107, the lid 107 may be a flip top lid 107. The lid 107 may include a recessed wall 108 with straight edges along the length of the lid 107 and rounded edges along the width of the lid 107. The circular edges may be configured to surround the batteries 110 and keep them in place. In some embodiments, the recessed wall 108 includes additional support to keep the batteries 110 in place, such as foam padding. In some embodiments, the lid 107 is secured magnetically. Additionally or alternatively, the recessed wall 108 may be slightly wider than the lip 109 on the top of the housing 101, such that closing the lid causes enough friction between the recessed wall 108 and the lip 109 to secure the lid 107. In some embodiments, the battery case 100 further includes a clasp for securing the lid 107 to the housing 101. Other mechanisms for securing the lid are possible, such as a latch, etc.

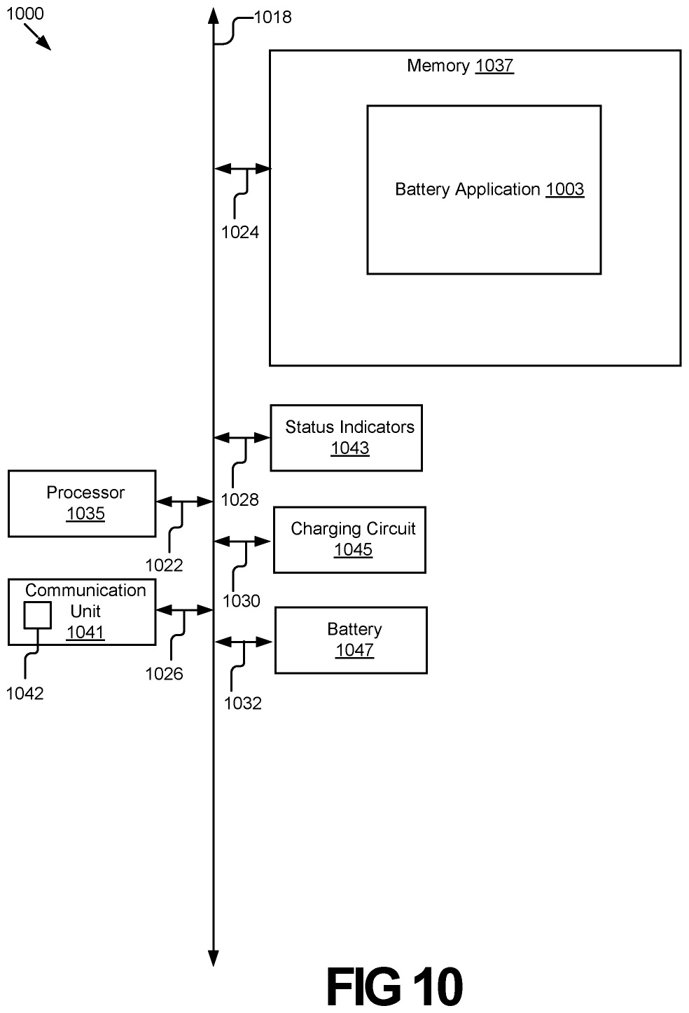

The battery case 100 includes internal components, such as processors, memory, circuit boards, sensors, and the like. In some embodiments, the battery case 100 includes a battery as illustrated in FIG. 10. The battery may be at least partially encapsulated within the body of the case, for example, by co-molding the battery into the case or by inserting the battery into a recess of the case. In some embodiments, the recess opens into the interior volume of the battery case 100, allowing the battery to be inserted into the recess without requiring an opening on the back surface. In some embodiments, the battery is not removable by a consumer and/or technician.

The battery may be coupled to a connector to provide electrical power to the battery case 100. The battery case 100 may also include additional components associated with the battery, such as charging circuitry, a processing unit, and the like, each of which may be encapsulated in the body of the battery case 100 along with the battery.

In some embodiments, the battery case 100 includes an antenna as illustrated in FIG. 10. The antenna may be a passive antenna or an active antenna. The antenna may be integrated into the housing 101. In some embodiments, the antenna includes one or more of a radio frequency identification (RFID), Bluetooth (BT), Bluetooth Low Energy (BLE), near field communication (NFC), or WiFi for communication with one or more of a user device or a server (e.g., for communication with the cloud). The hardware associated with the antennae may be used to identify the location of the battery case 100 and transmit the location of the battery case 100 to a battery application that is on a mobile device. In some embodiments, the hardware includes proximity detection functionality that is used to identify the location of the battery case.

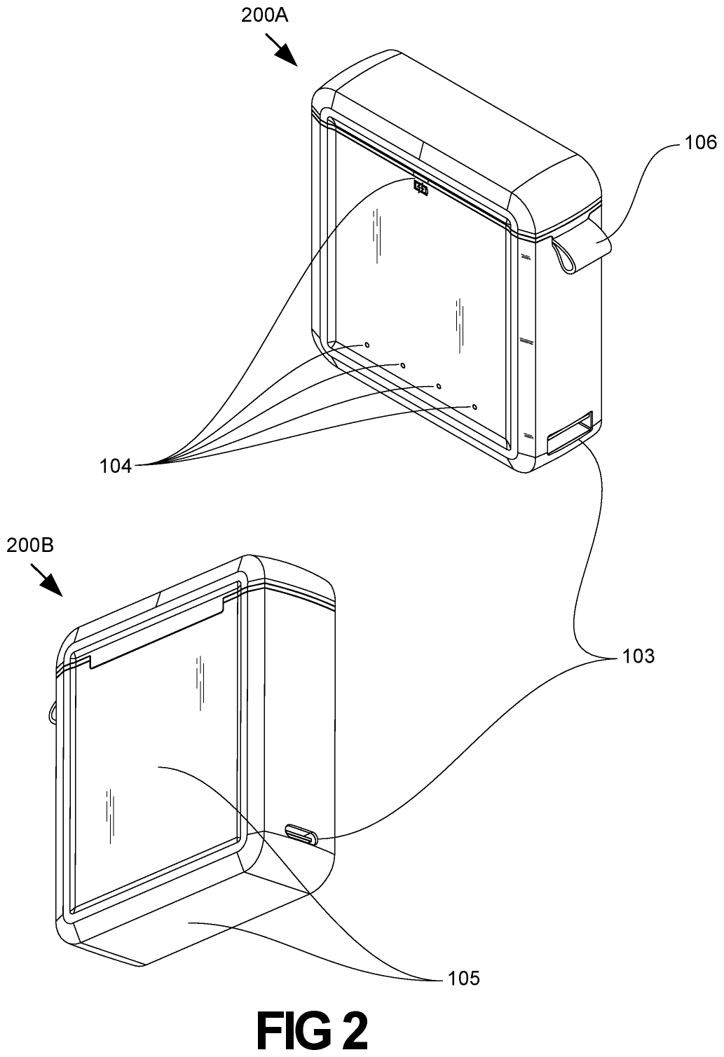

FIG. 2 illustrates a profile view of the battery case 200A from the front and a profile view of the battery case 200B from the back with a closed lid. The battery case 200 includes ports 103. In some embodiments a first port is a power-in port and a power-out port and a second port is a power-out port. The ports may include a universal serial bus (USB) connections, etc. The USB connections may include 1.1-2.0, 3.0, type A, type B, type C, mini A, mini B, micro A, micro B, micro B super speed, etc. In some embodiments, the power-in port is used for charging the battery case 200. In some embodiments, the power-in port is USB-C and the power-out port is USB-A.

In some embodiments, the battery case 200 includes at attachment loop 106. The attachment loop 106 may be made of plastic, leather, silicone, etc.

In some embodiments, the housing 101 includes status indicators 104 and 117 facing outward from the battery case 100 and operatively coupled to an input region and a battery (and/or charging circuitry, a processing unit, or the like). In this example, the status indicator 104 near the top of the lid is a battery with representation of a lightning bolt that is used to indicate that one or more batteries 110 are inside the case and are charging. This status indicator 104 may light up and/or flash when the batteries are charging. In some embodiments, the one or more batteries 110 are charged while the power-in port is plugged into an external power source or while the battery case 200 is not plugged into an external power source. In some embodiments, the battery case 200 is charged using an induction system (e.g., Qi wireless charging) where the battery case 200 is placed on a charging pad that charges the battery case 200 using resonant inductive coupling. The charging of the one or more batteries 110 and/or the battery case 200 may be quick charging.

The status indicators 104 towards the bottom of the case a plurality of light emitting components, such as a light-emitting diode (LED). In some embodiments, the battery case 200 includes one or more light pipes that attach from LEDs on the one or more batteries 110 to a surface of the housing 101. Light pipes are advantageous for use as status indicators 104 because they may be flexible or rigid, they can increase the apparent brightness of an LED, and they are affordable.

The status indicator 104 near the bottom of the battery case 100 indicates a progress of the charge or a status of the batteries when not being charged, for example, via push of a button. In one example, each light corresponds to a cylindrical cavity 102 for a battery 110 and the light is activated when the individual battery 110 is charged. In some embodiments, no light indicates that the battery case 100 is devoid of batteries 110 or not charging, a green light that flashes indicates a charging status, and a solid green light indicates that the battery 110 is charged.

The status indicator 117 may be an overall pack charge that is a single red blue green (RGB) LED that is activated by opening the lid or when charging. In some embodiments, the status indicator 117 may include no color to indicate 0% charge, red to indicate a charge of up to 20%, orange to indicate a charge of up to 40%, yellow to indicate a charge of up to 60%, light green to indicate a charge of up to 80%, and medium green to indicate a charge of up to 100%. Other colors and charge configurations are possible.

In another example, the status indicator 104 illuminates in proportion to the charge level of all the batteries 110 at once where one light indicates a minimum 25% charge, two lights indicate a minimum 50% charge, three lights indicate a minimum 75% charge, and four lights indicate a maximum charge. Other status indicators are possible. For example, the status indicator may be a progress bar or a single light-emitting diode (LED) that changes color based on the charging level. Other indicators are also possible, such as a user interface that displays statuses other than a state of charge, such as a time to full charge or a number of charge cycles used by the battery case 200.

In some embodiments, the battery case 200 includes an induction charging system. The induction charging system may be part of the housing 101 and take the form of a platform 105. For example, in FIG. 2, a user may turn the battery case 200 on its side to maximize the surface or upside down and rest the batteries 110 closest to the platform 105 in order to charge them.

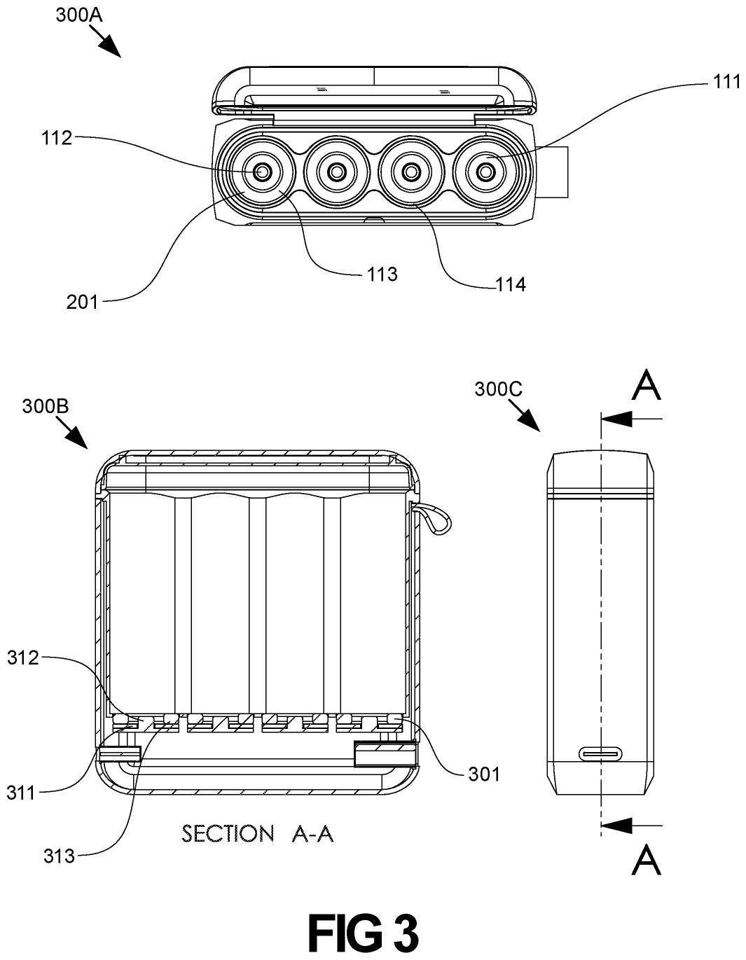

Turning to FIG. 3, a top-down view of the battery case 300A with the batteries 110 inside, a detailed profile view of the inside of the battery case 300B, and a side view of the battery case 300C are illustrated.

In some embodiments, as illustrated by the top-down view of the battery case 300A, the battery case 300A includes batteries 110. In this example, the batteries are positioned in the case with the positive terminal facing up; however, the batteries would be inserted with the positive terminal facing down in order to charge the batteries. The batteries 110 may be AA batteries; AAA batteries; camera batteries, such as CR123, CR2, 2CR5, CR-P2, CR-V3, CP1, 7R31; lithium-ion rechargeable batteries, such as 18650; or any combination thereof. For example, the batteries 110 may be lithium-ion rechargeable AAA batteries. Although the description is for rechargeable cylindrical batteries, people with ordinary skill in the art will understand that the technology could be applied to other types of batteries, for example, rectangular batteries, such as 9-volt batteries or button cells.

The batteries 110 include a housing 114, an electronically insulative material 111, a positive terminal 112, and a negative terminal 113. In this example, the batteries 110 include a positive terminal 112 and a negative terminal 113 where both are cylindrical. In some embodiments, the negative terminal surrounds the positive terminal. In some embodiments, the positive terminal surrounds the negative terminal. The electronically insulative material 111 insulates the positive terminal 112 from the negative terminal 113.

In some embodiments, the batteries 110 include a system on a chip (SoC), which is an integrated circuit that integrates some or all of an electronic system including a central processing unit (CPU), memory, input-output ports, and secondary storage. In some embodiments, the batteries 110 include an LED state of charge (SOC) indicator. For example, the LED SOC indicator may indicate whether the battery is charged or uncharged, a progressive charge for the battery, etc.

The detailed view of the inside of the battery case 300B includes a positive terminal 312, a negative terminal 313, electrically insulating material 311 that insulates the positive terminal 312 from the negative terminal 313, and a magnet 301. In some embodiments, each of the one or more cylindrical cavities has a magnet 301, a positive terminal 312, and a negative terminal 313.

In this example, the magnet 301 is located at the bottom of the cylindrical cavities 102, but the magnet 301 could be located anywhere include along the sides of the cylindrical cavities 102. The magnet 301 is used to secure the batteries 110 inside the cylindrical cavities 102 in order to improve the contacts for charging the batteries 110. The magnets 301 may be permanent magnets made from neodymium iron boron, samarium cobalt, alnico, ceramic, or ferrite. In some embodiments, the magnet 301 is an electromagnet. For example, the housing 101 could include a button that, when pressed by a user, releases one or more batteries 110. The electromagnet may draw power when the lid 107 is closed. Otherwise, the lid holds the batteries 110 securely inside the battery case 300B.

The side view of the battery case 300C includes arrows with “A” to indicate the midline of the battery case 300C. In this example, the port 103 is in the middle of the battery case 300C.

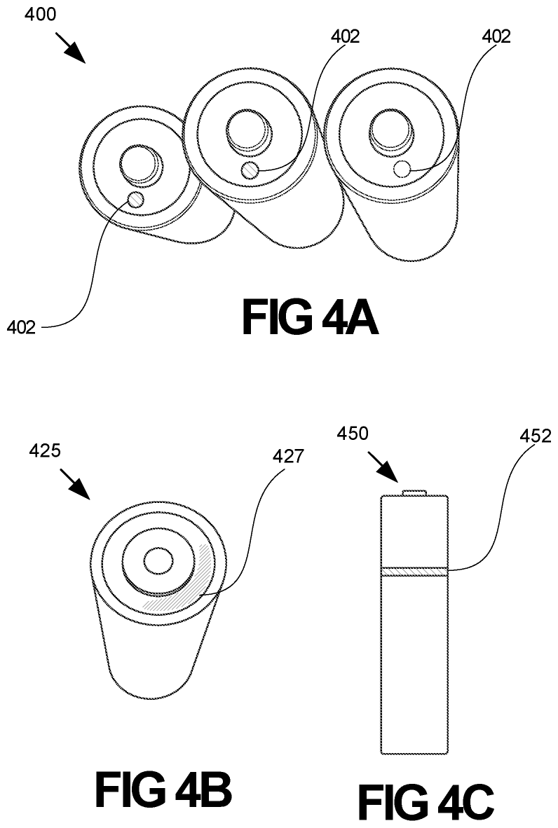

FIGS. 4A-C illustrates examples of batteries with state of charge (SOC) indicators. FIG. 4A illustrates batteries 400 with SOC indicators 402 on the top of the batteries 400 adjacent or circumferential to the positive terminal. The SOC indicators 402 are small circles that light up to indicate the charge. In this example, the SOC indicators 402 are green when the batteries have a charge and have no color if the batteries are not fully charged. In another example, the SOC indicators 402 may be green if the charge exceeds a threshold value. In another example, the SOC indicators 402 have no color if the charge falls below a threshold value. In yet another example, the SOC indicators 402 have no color if there is a 0% charge. Other options are possible, such as multiple colors that display different levels of charges.

FIG. 4B illustrates a battery 425 with a SOC indicator 427 on the top of the battery 425. In this example, the SOC indicator 427 changes to red when the battery 425 is uncharged.

FIG. 4C illustrates a battery 450 with a SOC indicator 452. In this example, the SOC indicator 452 is located on the side of the battery as a circumference of the battery 450. Alternatively, the SOC indicator 452 could be on the side of the battery, but at one point similar to the circle illustrated in FIG. 4A.

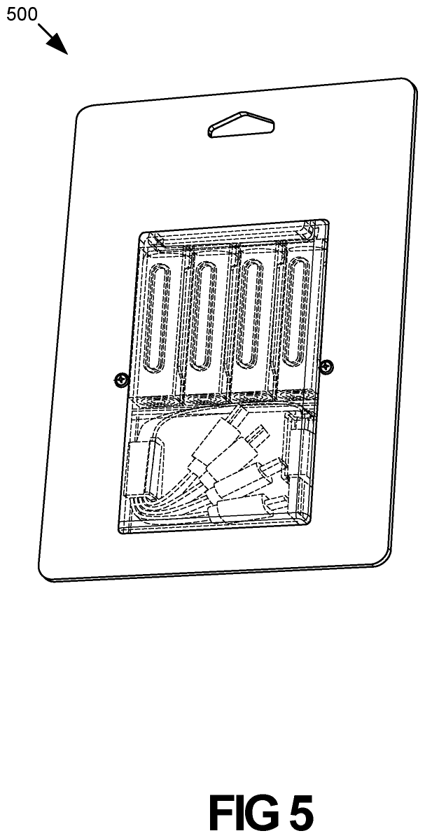

FIG. 5 illustrates a side view of the batteries inside a package card 500, according to some embodiments. In this example, the batteries 110 and charging cords are illustrated with dashed lines since different types of batteries and charging cords could be used. In some embodiments, the package card 500 is 2.5 mm thick cardstock, with paper that is laminated on both sides. The package card 500 is attached to a battery case with two screws that attach on the back side of the package card 500 to secure the battery case to the package card 500. Once a user purchases the batteries, the user may use them in conjunction with the charging case.

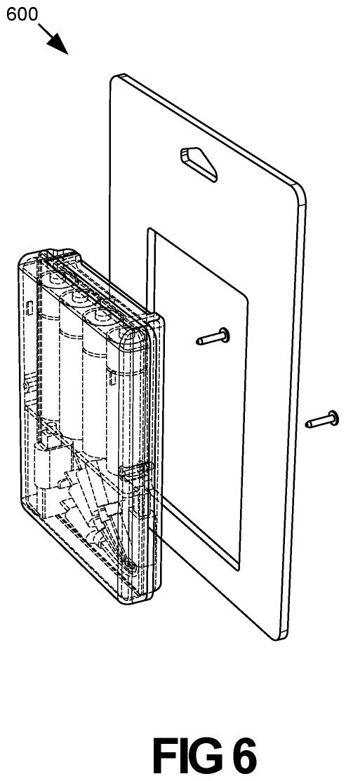

FIG. 6 illustrates an exploded view of the batteries inside a package card 600, according to some embodiments. This example illustrates where the screws fit into the batteries case in order to secure the batteries case to the package card 600.

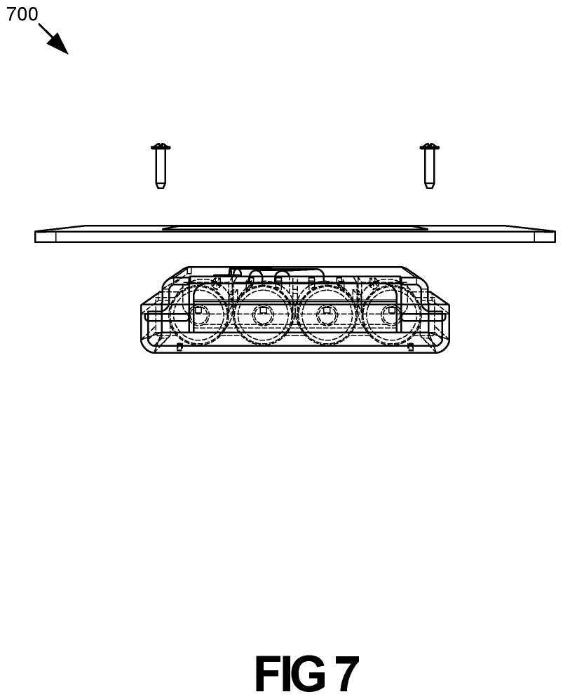

FIG. 7 illustrates an exploded top-down view of batteries inside a package card 700, according to some embodiments.

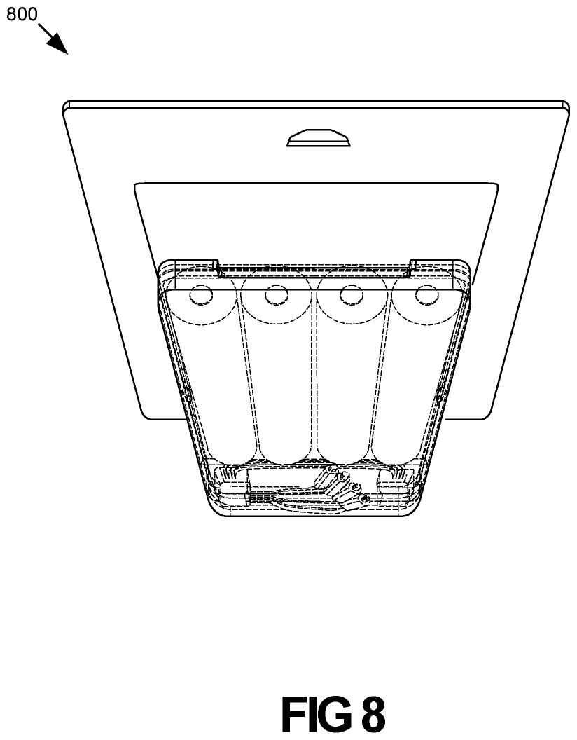

FIG. 8 illustrates a top view of the batteries inside a package card 800, according to some embodiments.

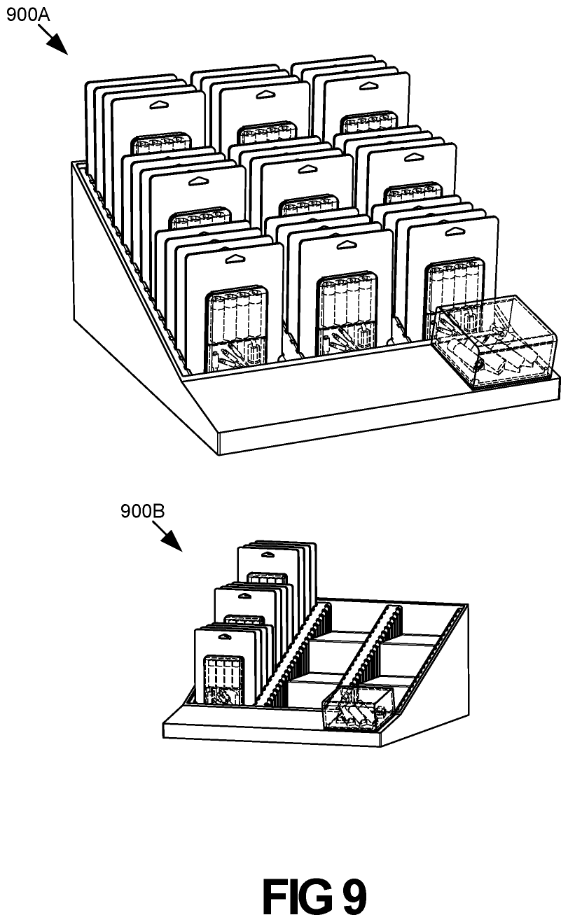

FIG. 9 illustrates cases 900A, 900B with multiple batteries inside package cards, according to some embodiments.

FIG. 10 illustrates hardware components 1000 of the battery case, according to some embodiments. The hardware components 1000 may include a processor 1035, a memory 1037, a communication unit 1041, status indicators 1043, charging circuit 1045, and a battery 1047. Additional components may be present or some of the previous components may be omitted. A battery application 1003 may be stored in the memory 1037. The components of the hardware components 1000 may be communicatively coupled by a bus 1018. Bus 1018 may be a communication bus that carries signals between various hardware components 1000.

The processor 1035 includes an arithmetic logic unit, a microprocessor, a general-purpose controller, or some other processor array to perform computations and provide instructions to a display device. Processor 1035 processes data and may include various computing architectures including a complex instruction set computer (CISC) architecture, a reduced instruction set computer (RISC) architecture, or an architecture implementing a combination of instruction sets. Although FIG. 10 illustrates a single processor 1035, multiple processors 1035 may be included. In different embodiments, processor 1035 may be a single-core processor or a multicore processor. Other processors (e.g., graphics processing units), operating systems, sensors, displays, and/or physical configurations may be part of the hardware components 1000. The processor 1035 is coupled to the bus 1018 for communication with the other components via signal line 1022.

The memory 1037 stores instructions that may be executed by the processor 1035 and/or data. The instructions may include code and/or routines for performing the techniques described herein. The memory 1037 may be a dynamic random access memory (DRAM) device, a static RAM, or some other memory device. In some embodiments, the memory 1037 also includes a non-volatile memory, such as a static random access memory (SRAM) device or flash memory, or similar permanent storage device and media including a hard disk drive, a compact disc read only memory (CD-ROM) device, a DVD-ROM device, a DVD-RAM device, a DVD-RW device, a flash memory device, or some other mass storage device for storing information on a more permanent basis. The memory 1037 includes code and routines operable to execute the battery application 1003, which is described in greater detail below. The memory 1037 is coupled to the bus 1018 for communication with the other components via signal line 1024.

The battery application 1003 may include code and routines operable to monitor a state of charge of the rechargeable batteries 110 and communicate with the user device or the server. In some embodiments, the battery application 1003 may be implemented using hardware including a central processing unit (CPU), a field-programmable gate array (FPGA), an application-specific integrated circuit (ASIC), any other type of processor, or a combination thereof. In some embodiments, the battery application 1003 may be implemented using a combination of hardware and software.

The communication unit 1041 transmits data to and receives data from the battery case. In some embodiments, the communication unit 1041 includes an antenna 1042 for exchanging data with a user device or a server, or other communication channels using one or more wireless communication methods, including IEEE 802.11, IEEE 802.16, Bluetooth®, Bluetooth® Low Energy, RFID, WiFi, or another suitable wireless communication method. In some embodiments, the communication unit 1041 receives status information about the batteries from the battery application 1003 and transmits the status information to a user device or a server via the antenna 1042. The communication unit 1041 is coupled to the bus 1018 for communication with the other components via signal line 1026.

The status indicators 1043 may include hardware for displaying a status of the battery, such as an LED, a display that displays a graphical user interface, etc. The status indicators 1043 are coupled to the bus 1018 for communication with the other components via signal line 1028.

The charging circuit 1045 monitors the charge state of the rechargeable batteries 110 illustrated in FIG. 1 and the battery 1047 and other parameters or aspects of the batteries and control the charging of the batteries (e.g., by regulating the electric power delivered to the batteries for charging. The charging circuit 1045 is coupled to the bus 1018 for communication with the other components via signal line 1030.

The battery 1047 may be a supplemental battery disposed within the battery case and configured to provide power to an electronic device housed within the case. The battery may be operatively coupled to a charging circuit 1045. The battery 1047 is coupled to the bus 1018 for communication with the other components via signal line 1032.

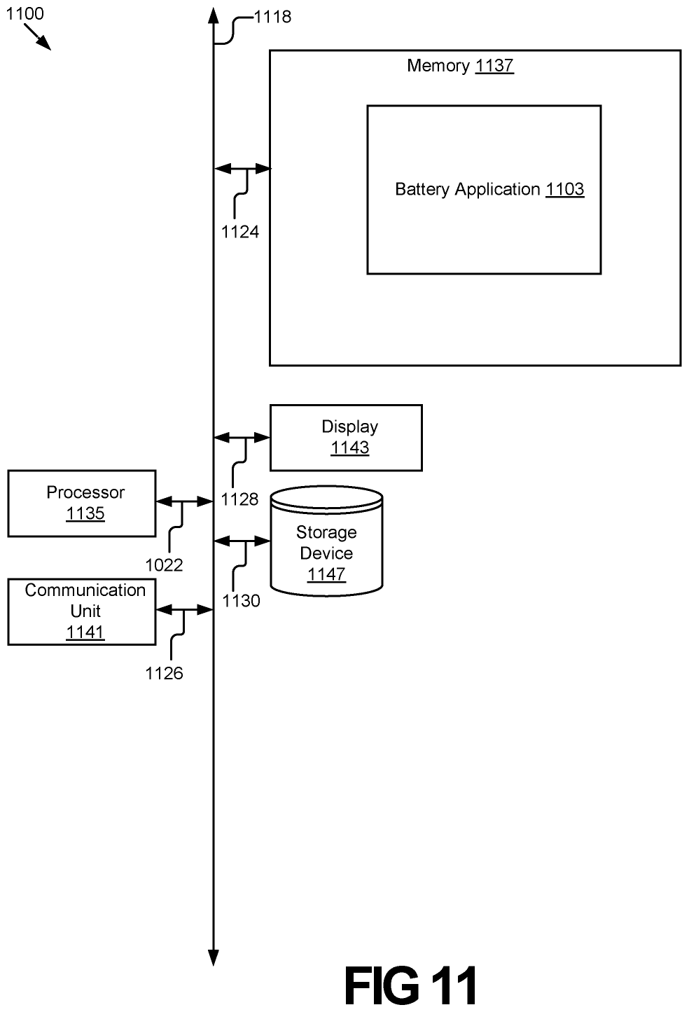

FIG. 11 illustrates a computing device 1100 that includes software that communicates with the battery case, according to some embodiments. The computing device 1100 may be a user device or a server. The computing device 1100 may include a processor 1135, a memory 1137, a communication unit 1141, a display 1143, and a storage device 1147. Additional components may be present or some of the previous components may be omitted depending on the type of computing device 1100. A battery application 1103 may be stored in the memory 1137. Bus 1118 may be a communication bus that carries signals between various parts of computing device 1100.

The processor 1135 includes an arithmetic logic unit, a microprocessor, a general-purpose controller, or some other processor array to perform computations and provide instructions to a display device. Processor 1135 processes data and may include various computing architectures including a complex instruction set computer (CISC) architecture, a reduced instruction set computer (RISC) architecture, or an architecture implementing a combination of instruction sets. Although FIG. 11 illustrates a single processor 1135, multiple processors 1135 may be included. In different embodiments, processor 1135 may be a single-core processor or a multicore processor. Other processors (e.g., graphics processing units), operating systems, sensors, displays, and/or physical configurations may be part of the computing device 1100. The processor 1135 is coupled to the bus 1118 for communication with the other components via signal line 1122.

The memory 1137 stores instructions that may be executed by the processor 1135 and/or data. The instructions may include code and/or routines for performing the techniques described herein. The memory 1137 may be a dynamic random access memory (DRAM) device, a static RAM, or some other memory device. In some embodiments, the memory 1137 also includes a non-volatile memory, such as a static random access memory (SRAM) device or flash memory, or similar permanent storage device and media including a hard disk drive, a compact disc read only memory (CD-ROM) device, a DVD-ROM device, a DVD-RAM device, a DVD-RW device, a flash memory device, or some other mass storage device for storing information on a more permanent basis. The memory 1137 includes code and routines operable to execute the battery application 1103, which is described in greater detail below. The memory 1137 is coupled to the bus 1118 for communication with the other components via signal line 1124.

The battery application 1103 may include code and routines operable to generate a graphical user interface to display information about the battery case 100. In some embodiments, the battery application 1103 may be implemented using hardware including a central processing unit (CPU), a field-programmable gate array (FPGA), an application-specific integrated circuit (ASIC), any other type of processor, or a combination thereof. In some embodiments, the battery application 1103 may be implemented using a combination of hardware and software.

In some embodiments, the battery application 1103 generates graphical, numerical, visual, or other data about a charge status of the batteries (e.g., a progress bar, a progress wheel, a percentage, a visualization of a charge in the cylinder, etc.), an estimated time to charge the batteries, charging lifecycles, a power consumption rate, ambient environmental conditions, such as horrent and historical temperature and air quality, etc. In some embodiments, the battery application 1103 generates a warning notification if the battery case is overheating and/or if a customer is acting in a way that can damage the batteries.

In some embodiments, the battery application 1103 generates a graphical user interface that includes options for modifying the settings. For example, the graphical user interface has options for implementing a fast-charging process or a regular charging process. In some embodiment, the graphical user interface includes an option for balancing a charge state on all batteries in the case without needing access to external power. For example, if a battery case includes two full batteries and two dead batteries, rebalancing the charge would result in four half charged batteries. In some embodiments, the graphical user interface includes an option for providing a unique identifier for a battery so that the battery application 1103 can monitor a number of times the battery has been recharged and predict a lifespan of the battery. In some embodiments, the graphical user interface includes an option for displaying push notifications via the battery application 1103 when the batteries are fully charged or charged a threshold amount.

In some embodiments, the battery application 1103 receives information about the location of the battery case, such as proximity detection. The battery application 1103 may include an option for using the location of the battery case to help find a lost or misplaced battery case. For example, the battery application 1103 may generate a graphical user interface with a map that identifies a location of the battery case.

The communication unit 1141 transmits data to and receives data from the battery case. In some embodiments, the communication unit 1141 includes a wireless transceiver for exchanging data with the battery case, or other communication channels using one or more wireless communication methods, including IEEE 802.11, IEEE 802.16, Bluetooth®, Bluetooth® Low Energy, WiFi, or another suitable wireless communication method. The communication unit 1141 is coupled to the bus 1118 for communication with the other components via signal line 1126.

The display 1143 may include hardware operable to display graphical data received from the battery application 1103. For example, the display 1143 may render graphics to display a charge status of the batteries, an estimated time to charge the batteries, etc. Display 1145 may be any type of display, e.g., a liquid crystal display (LCD), OLED, etc. The display 1143 is coupled to the bus 1118 for communication with the other components via signal line 1128.

The storage device 1147 may be a non-transitory computer-readable storage medium that stores data that provides the functionality described herein. The storage device 1147 may be a DRAM device, a SRAM device, flash memory or some other memory device. In some embodiments, the storage device 1147 also includes a non-volatile memory or similar permanent storage device and media including a hard disk drive, a CD-ROM device, a DVD-ROM device, a DVD-RAM device, a DVD-RW device, a flash memory device, or some other mass storage device for storing information on a permanent basis. The storage device 1147 is coupled to the bus 1118 for communication with the other components via signal line 1130.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one implementation of the description. The appearances of the phrase “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMs, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A charging device comprising:
a housing forming one or more cylindrical cavities that each receive a rechargeable battery, the one or more cylindrical cavities each having a magnet and an end that includes both a positive terminal and a negative terminal;
a status indicator for one or more of the rechargeable batteries;
an antenna; and
an induction charging system.

2. The charging device of claim 1, wherein the positive terminal and the negative terminal are cylindrical and the negative terminal surrounds the positive terminal.

3. The charging device of claim 1, wherein the positive terminal and the negative terminal are cylindrical and the positive terminal surrounds the negative terminal.

4. The charging device of claim 2, wherein the positive terminal and the negative terminal are separated by an electronically insulative material.

5. The charging device of claim 1, wherein the status indicator includes a representation of a battery with a lightning bolt that indicates when the rechargeable battery is charging.

6. The charging device of claim 1, wherein the status indicator includes one or more lights that each change color to indicate a state of charge of the rechargeable battery or that the rechargeable battery is charged.

7. The charging device of claim 1, wherein the status indicator includes one or more of a progress bar or a light-emitting diode that changes color based on a progress level of the rechargeable battery.

8. The charging device of claim 1, further comprising one or more light pipes that attaches from the rechargeable battery to the housing.

9. The charging device of claim 1, wherein the housing further includes a platform that includes the induction charging system.

10. The charging device of claim 1, further comprising a first port that is a power-in port and a power-out port and a second port that is a power-out port.

11. The charging device of claim 1, wherein the antenna includes one or more of a one or more of a radio frequency identification (RFID), Bluetooth (BT), Bluetooth Low Energy (BLE), near field communication (NFC), or WiFi for communication with one or more of a user device or a server.

12. A battery comprising:
a housing comprising a positive terminal forming a cylinder;
electronically insulation material surrounding the positive terminal; and
a negative terminal forming a ring that surrounds the insulation material and the cylinder.

13. The battery of claim 12, wherein the battery is one or more of a AA battery, a AAA battery, a camera battery, or a lithium-ion rechargeable battery.

14. The battery of claim 12, further comprising a state of charge indicator that indicates when the battery is charged.

15. The battery of claim 14, wherein the state of charge indicator is located on top of the battery or on a side of the battery.

16. A computer-implemented method comprising:
receiving a status of one or more rechargeable batteries from a battery case;
generating graphical data about the status of the one or more rechargeable batteries; and
displaying the graphical data about the status of the one or more rechargeable batteries.
